(19) United States
(12) Patent Application Publication
(10) Pub. No.: US 2015/0130637 A1
(43) Pub. Date: May 14, 2015

(54) Wireless Moisture Sensing Device, System, and Related Methods

(71) Applicant: Trackblue, LLC, Hollis, NH (US)

(72) Inventor: Robert W. Sengstaken, JR., Hollis, NH (US)

(21) Appl. No.: 14/536,797

(22) Filed: Nov. 10, 2014

Related U.S. Application Data
(63) Continuation-in-part of application No. 14/304,195, filed on Jun. 13, 2014.
(60) Provisional application No. 61/902,323, filed on Nov. 11, 2013.

(51) Int. Cl. G08C 17/02

(52) U.S. Cl. CPC G08C 17/02
USPC 340/870.16

(57) ABSTRACT

A system for wireless moisture sensing includes a housing and a wireless transmitter located within the housing. A processor is located within the housing, wherein the processor is in communication with the wireless transmitter. A timer is in communication with the processor, wherein the timer communicates a wake-up signal to the processor at a predetermined interval of time. An activation device is in communication with the processor and a battery is located within the housing. At least one moisture sensor is in communication with the processor.

### CROSS REFERENCE TO RELATED APPLICATION

This application is a continuation-in-part application of U.S. application Ser. No. 14/304,195 entitled, “Asset Tag Apparatus and Related Methods” filed Jun. 13, 2014 and also claims benefit of U.S. Provisional Application Ser. No. 61/902,323 entitled, “Bluetooth Wireless Moisture and Diaper Sensor” filed, Nov. 11, 2013.

### FIELD OF THE DISCLOSURE

The present disclosure is generally related to a sensing, monitoring and locating device, and more particularly is related to a wireless moisture sensing device, system and related methods.

### BACKGROUND OF THE DISCLOSURE

Radio-based asset-tracking systems are used in various enterprises, such as hospitals, moving and shipping companies, and other facilities with movable assets to track various assets to provide the enterprise or other party with knowledge of the location of the asset. The asset-tracking systems often use wireless tags that are connected to assets to help track the location of the asset. Installing the infrastructure to enable asset tracking is normally relatively expensive and the asset tag typically has sufficient power to operate for a few months before its batteries are dead. The relatively short lifespan is due to several factors. One factor is that the tags are location-aware, which means they receive signals from infrastructure that are associated with particular locations, and the tags then have to report the location data back to an asset tracking system. The tags also normally use a two-way protocol, which includes sending a message and receiving an acknowledgement of receipt. Furthermore, the costs of the infrastructure for many conventional tracking systems, including RFID readers for passive RFID tags, can be prohibitively high to prospective users.

The need for an asset tag that has sufficient battery power to operate for the life of the asset, or a substantial portion of the life of the asset, is a critical factor in industries today. Having to replace a battery of an asset tag or replace the entirety of the asset tag is an expensive and often time consuming process. Many assets will require tags with lifespans of many years. Additionally, it can be difficult to determine the optimal time for replacement of a battery of the asset tag, thereby leaving the user at risk of the asset tag fully losing power and subsequently failing. Some low-power radios have been used to increase battery life, but these devices have shorter transmission range requiring the RF infrastructure to relay. When the assets being tracked are highly mobile, e.g., cattle or international shipping containers, having an asset tag which no longer functions to track the asset is highly undesirable.

One facet of asset monitoring involves the ability to sense or monitor for certain conditions within the asset, for example, the ability to monitor for moisture within an asset. Conventional moisture sensing is generally performed by measuring the conductivity between two conductors positioned in a location where moisture is anticipated. When the two conductors are electrically connected, the sensor provides an indication to the user that moisture has been detected. However, conventional devices suffer from the inability to differentiate sensed moisture from a broken connection within the conductors. Additionally, the ability to receive the signals from multiple sensor tags with standard smartphones and tablet computers is highly desirable as well as fixed infrastructure receivers.

Thus, a heretofore unaddressed need exists in the industry to address the aforementioned deficiencies and inadequacies.

### SUMMARY OF THE DISCLOSURE

Embodiments of the present disclosure provide a system for wireless moisture sensing. Briefly described, in architecture, one embodiment of the system, among others, can be implemented as follows. The system for wireless moisture sensing includes a housing. A wireless transmitter is located within the housing. A processor is located within the housing, wherein the processor is in communication with the wireless transmitter. A timer is in communication with the processor, wherein the timer communicates a wake-up signal to the processor at a predetermined interval of time. An activation device is in communication with the processor. A battery is located within the housing. At least one moisture sensor is in communication with the processor.

The present disclosure can also be viewed as providing a wireless moisture-sensing device. Briefly described, in architecture, one embodiment of the device, among others, can be implemented as follows. The wireless moisture-sensing device includes a wireless module. The wireless module comprises a housing, a wireless transmitter located within the housing, the wireless transmitter transmitting signals in an ISM band of between 2.4 GHz to 2.485 GHz, a processor located within the housing, wherein the processor is in communication with the wireless transmitter, a timer in communication with the processor, wherein the timer is communicating a wake-up signal to the processor at a predetermined interval of time, and a battery located within the housing. The wireless module further comprises an activation device in communication with the processor, wherein the activation device comprising at least one of: an accelerometer in communication with the processor, wherein physical movement of the accelerometer activates the processor; a magnet activation device in communication with the processor, wherein the processor is activated by the magnetic activation device upon influence from a magnetic field; and a push-activation device in communication with the processor, wherein the processor is activated by the push-activation device upon physical contact applied to the push-activation device. At least one moisture sensor has at least four conductors, wherein the at least one moisture sensor is removably coupled to the wireless module, wherein at least a portion of the at least four conductors are in removable communication with the processor.

The present disclosure can also be viewed as providing a method for sensing moisture with a wireless tagging system. In this regard, one embodiment of such a method, among others, can be broadly summarized by the following steps: pairing a wireless module to a moisture sensor, the wireless module having a wireless transmitter, a processor, and a timer in communication with the processor; transmitting a wake-up signal from the timer to the processor at a predetermined interval of time; activating the processor from a sleep state upon receiving the wake-up signal transmitted from the timer; upon activation of the processor, determining a connection to the moisture sensor by applying a voltage to at least two conductors of the moisture sensor, and then determining a presence of a quantity of moisture with the moisture sensor by applying a second voltage to at least one conductor of the moisture sensor; and transmitting a signal externally from the housing using the wireless transmitter in response to the wake-up signal received by the processor, wherein the signal corresponds to the determined presence of the quantity of moisture.

Other systems, methods, features, and advantages of the present disclosure will be or become apparent to one with skilled in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic illustration of a system for wireless moisture sensing, in accordance with a first exemplary embodiment of the present disclosure.

FIG. 2 is a schematic of the system for wireless moisture sensing of FIG. 1, in accordance with the first exemplary embodiment of the present disclosure.

FIG. 3 is a schematic of the computerized device used with the system for wireless moisture sensing of FIGS. 1-2, in accordance with the first exemplary embodiment of the present disclosure.

FIG. 4 is a schematic of the system for wireless moisture sensing, in accordance with a second exemplary embodiment of the present disclosure.

FIG. 5 is a schematic of the system for wireless moisture sensing, in accordance with the second exemplary embodiment of the present disclosure.

FIG. 6 is a front view diagram of the system for wireless moisture sensing in use with an asset, in accordance with the second exemplary embodiment of the present disclosure.

FIG. 7 is a cross-sectional side view diagram of the system for wireless moisture sensing in use with an asset, in accordance with the second exemplary embodiment of the present disclosure.

FIG. 8 is a schematic of the system for wireless moisture sensing, in accordance with the second exemplary embodiment of the present disclosure.

FIG. 9 is a flowchart of a method for sensing moisture with a wireless tagging system, in accordance with the first exemplary embodiment of the present disclosure.

### DETAILED DESCRIPTION

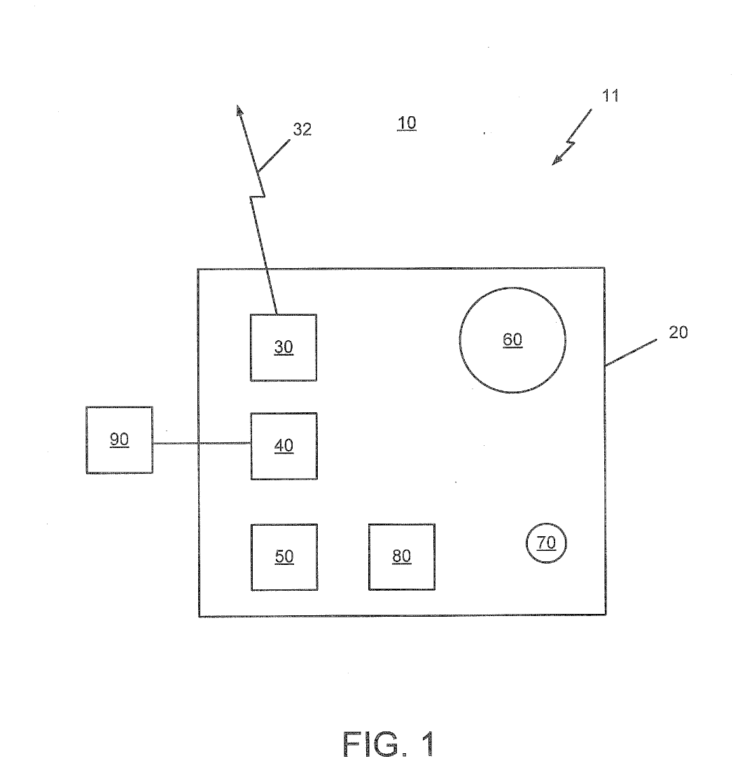

FIG. 1 is a schematic illustration of a system for wireless moisture sensing 10, in accordance with a first exemplary embodiment of the present disclosure. The system for wireless moisture sensing 10, which may be referred to simply as ‘system 10’ includes a housing 20. A wireless transmitter 30 is located within the housing 20. A processor 40 is located within the housing 20, wherein the processor 40 is in communication with the wireless transmitter 30. A timer 80 is in communication with the processor 40, wherein the timer 80 communicates a wake-up signal to the processor 40 at a predetermined interval of time. A battery 60 is located within the housing 20. An activation device 50 is in communication with the processor 40. At least one moisture sensor 90 is in communication with the processor 40. At a minimum, the wireless transmitter 30, the processor 40, timer 80, battery 60, and activation device 50 are positioned within the housing 20 to form a substantially unitary wireless tag device 11 (“wireless tag device 11”).

The system 10 may be used in a variety of industries and enterprises to sense moisture for any number or type of assets. For example, the system 10 may be used within the caretaking industry to track moisture within personal sanitary products, such as diapers, or other personal products that are likely to become wet. The system 10 may also be used to monitor moisture in buildings, structures, or other settings where there is a moisture barrier intended to prevent moisture from entering the setting, such as a roof In this situation, the moisture barrier has the potential to fail and allow moisture to enter the setting. It may also be used in other settings, such as in agriculture to measure soil moisture or with a piece of machinery to detect fluid leaks. The system 10 may be used for monitoring in positions where moisture is anticipated or likely.

The system 10 includes a housing 20 which may provide the structure for holding other components of the system 10. The housing 20 may be constructed from a durable material, such as hardened plastic, fiberglass, metal, or another type of material, and may substantially contain the wireless transmitter 30, the processor 40, the activation device 50, the timer 80, and the battery 70, along with other components of the system 10. The housing 20 may be sealable and resistant to the elements, such that it is water resistant, dust proof, and resistant to other environmental conditions. It may be highly desirable to have a waterproof housing 20, since when the accelerometer is used to detect an activation, a waterproof housing 20 may reduce the frequency and cost of leakage failures of a pushbutton. A magnetic sensor and magnet can also be used to activate the process of transmitting a signal externally from the housing using the wireless transmitter in response to the wake-up signal received by the processor, but at additional cost.

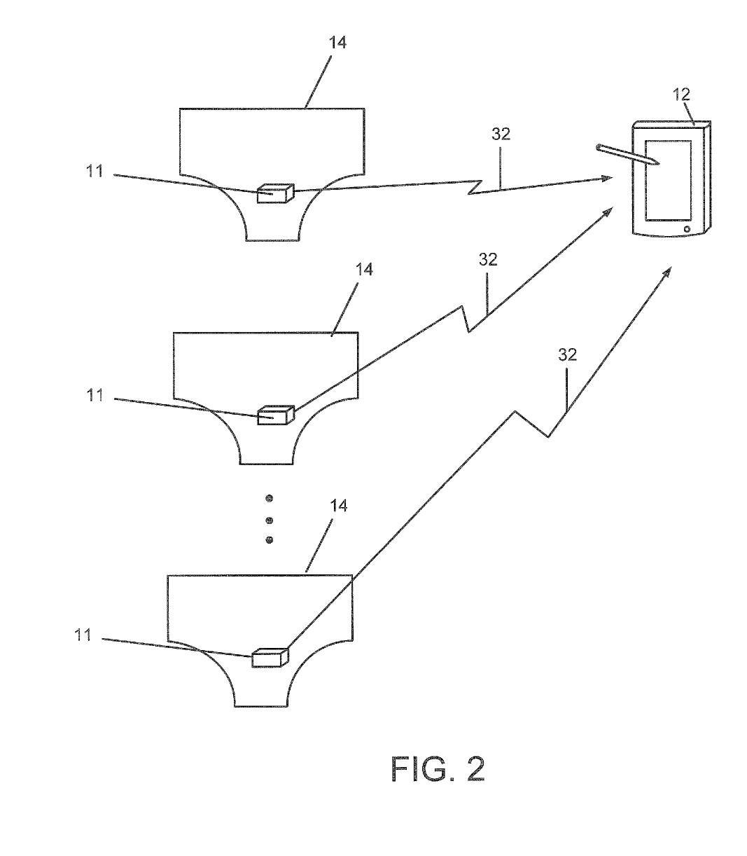

The wireless transmitter 30 is located within the housing 20 and is capable of transmitting signals external of the housing 20. For example, the wireless transmitter 30 may transmit signals to computerized devices capable of receiving a signal, as discussed relative to FIG. 2. While it is possible for wireless transmission according to a variety of transmission protocols, the wireless transmitter 30 may transmit the signal using short-wavelength UHF radio waves in an ISM band of between 2.4 GHz and 2.485 GHz, commonly referred to under the brand name Bluetooth®. The wireless transmitter 30 may include a variety of different types of transmitters capable of transmitting a wireless signal. The wireless transmitter 30 may include wireless microcontrollers (MCU) where the processor 40 is integrated within the MCU. Accordingly, the processor 40 can be in communication with the wireless transmitter 30 when integrated within the MCU or when used within the system 10 separate from the wireless transmitter 30. The processor 40 may include any type of central processing unit or microprocessor.

The activation device 50 may include a number of activation devices or systems. For example, the activation device 50 may include an accelerometer in communication with the processor 40, wherein physical movement of the accelerometer activates the processor 40. The activation device 50 may also include a magnet activation device in communication with the processor 40, wherein the processor 40 is activated by the magnetic activation device upon influence from a magnetic field. In this example, the magnetic field may be created by a magnet passing in the proximity of the activation device 50. In another example, the activation device 50 may include a push-activation device in communication with the processor 40, wherein the processor 40 is activated by the push-activation device upon physical contact applied to the push-activation device. In this example, the push-activation device may include a physical button or depressible feature which the user can engage to activate the activation device 50. As is discussed herein, the activation device 50 may be used to identify the wireless tag device 11 upon an initial set up or use of the wireless tag device 11. Once the wireless tag device 11 is operational and fully functioning, the activation device 50 may lie dormant.

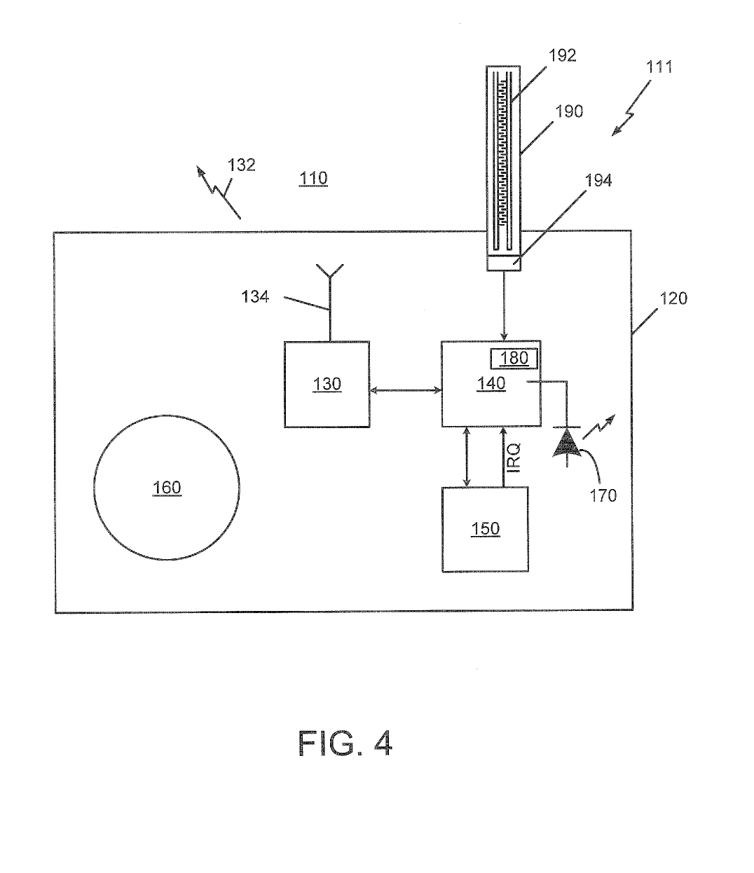

The at least one moisture sensor 90 may include any number of sensors capable of determining the presence of moisture in any form. For example, the moisture sensor 90 may be capable of determining the presence of various natural and synthetic fluids, including water, human bodily fluids, chemicals, or other moisture-creating substances. The moisture sensor 90 may be positioned to detect the moisture by being formed integral with an asset, such as a product that is likely to receive moisture. For example, the moisture sensor 90 may be formed within the absorbent portion of a diaper, such as embedded between the layers of the diaper. In other configurations, the moisture sensor 90 can be mounted or located in positions that may receive moisture, apart from an asset. For example, the moisture sensor 90 may be positioned at a roof line of a habitable building to detect a leaky roof, or it may be positioned on various locations of a piece of machinery to detect a fluid leak. In another example, the moisture sensor 90 may be positioned within an article of bedding, such as a mattress pad. Further details about the moisture sensor 90 are provided relative to FIGS. 4-8.

The system 10 may include a variety of other components, parts, and functions. For example, the system 10 may include a battery 60 located within the housing 20 and providing a quantity of power to the processor 40 and the activation device 50, as well as other components of the system 10. The battery 60 may include any variety of battery types sufficient to power the components of the system 10. An indicator 70 may also be included with the system 10. The indicator 70 may include any type of device capable of providing an indication to a user of the system 10, commonly in the form of a visual illumination or audible tone. For example, the indicator 70 may be a LED housed within the housing 20 which is capable of providing a visual indication, or audible indicator which makes an audible tone, among other types of indicators 70. The system 10 may further include a timer 80 positioned within the housing 20 which is capable of controlling timed transmission of instructions to the processor 40 at predetermined intervals, as will be discussed further herein.

When the system 10 is in use, it may provide successful monitoring of moisture within assets with efficient battery usage. To conserve battery power within the system 10, the processor 40 may remain in a sleep state unless activated. The sleep state may be characterized as an idle state of functioning of the processor 40 whereby it remains inactive and uses very little or no battery power. The wireless transmitter 30 may also reside in a power-conservation state unless activated by the processor 40. In use, for example, the processor 40 and wireless transmitter 30 may remain within the sleep state until activated by the activation device 50, which transmits a wake-up signal to the processor 40 when the activation device 50 is activated. Once the wake-up signal is received at the processor 40, the processor 40 may move from a sleep state to an active state. Accordingly, in this example, the processor 40 may be in a functioning state and thus use power when activated by the activation device 50, which can substantially preserve battery power over the life of the system 10. The activation device 50 may be in a functioning, non-idle state at all times when it is inactivate, which requires power from the battery 60. The activation device 50 may use less than 10 μAh (microampere-hours) of the quantity of power.

When the processor 40 is activated or awoken by receipt of the transmitted wake-up signal, the processor 40 may direct the wireless transmitter 30 to transmit the signal 32 external of the housing 20, such as to the computerized device. The specific characteristics of the signal 32 may vary depending on the design and intended use of the system 10. For example, the wireless transmitter 30 may transmit the signal 32 externally from the housing 20 at a repetition rate of at least one transmission per second. While other rates of transmission of the signal 32 may be used, a rate of 10 transmissions of the signal 32 per section may allow a wireless receiver to identify the signal 32 over other signals that may be transmitted. For example, when a plurality of system 10 are used, a wireless receiver may receive hundreds of signals from various wireless tag devices 11, which may substantially increase the time it takes to identify the signal 32. By increasing the repetition rate of transmission of the signal 32, the specific system 10 transmitting that signal may become more identifiable by the wireless receiver.

The timer 80 within the wireless tag device 11 may be used to control periodic transmissions of the signal 32 using the processor 40. While the system 10 may be conserving power during a substantial portion of its use, it may be necessary to periodically transmit a signal external from the housing 20 to communication information from the system 10, or to otherwise verify that the system 10 is functioning properly. A wake-up signal may be communicated from the timer 80 to the processor 40 at a predetermined repetition rate, such as no more than one transmission per ten seconds; however, the repetition rate of the transmission of the wake-up signal may vary. The wireless transmitter 30 may then transmit the signal 32 externally from the housing 20 in response to the second wake-up signal at the predetermined repetition rate.

The signal 32 transmitted from the wireless transmitter 30 may include data representative of a variety of information. For example, the signal may include a beacon, especially when the signal 32 is transmitted in response to a wake-up signal from the timer 80. The beacon may include a unique tag address, a manufacture code, a battery status, and sensor data, among other information. The signal 32 having the beacon may be transmitted at a specific repetition rate, wherein the specific repetition rate is dependent upon a sensor located at least partially within the housing. Any number or type of other sensors may be included with the system 10, housed within the housing 20. For example, the other sensors may include a humidity sensor, a temperature sensor, a proximity sensor, a Near Field Communications (NFC) reader, a Radio Frequency Identification (RFID) reader, and a magnetic field sensor, or another type of sensor.

The processor 40 may be in sleep state to preserve battery 60 levels, and at periodic time intervals, check the status of the moisture sensor 90. If there is a change of state within the moisture sensor 90, such as a detected disconnect, connect, bad connection, or moisture detected, the processor 40 will send out signal beacons at a higher rate for a predetermined period of time so that it can be immediately be received when there may be many other sensor tags present. The wireless tag device 11 may also provide a visual or audio indication with the change in state.

FIG. 2 is a schematic of the system for wireless moisture sensing 10 of FIG. 1, in accordance with the first exemplary embodiment of the present disclosure. With reference to FIGS. 1-2, a plurality of wireless tag devices 11 may be used in combination with one another and in combination with a computerized device 12. As is shown in FIG. 2, each of the wireless tag devices 11 may be secured to an asset 14, for example, a diaper as is shown in FIG. 2. The wireless tag device 11 may be secured to the asset 14 in a variety of ways, including affixing the wireless tag device 11 to an external surface of the asset 14, placing the wireless tag device 11 within the asset 14, such as by embedding the wireless tag device 11 within a layer of the diaper, or any other way of pairing the wireless tag device 11 to the asset 14 such that it stays connected to the asset 14. The wireless tag device 11 may transmit signals to the computerized device 12, depicted as a smart phone.

The computerized device 12 may include any type of computer, computer system, or other device utilizing a computer processor. For example, the computerized device 12 may include a personal computer (PC), a laptop computer, a notebook computer, a computerized smart phone, cellular phone, a PDA, a computerized tablet device, or another device. Commonly, the computerized device 12 may be a smart phone, such as an iPhone®, an Android™ phone, or any other cellular phone. The computerized device 12 may include a variety of hardware and software components, including one or more processors, memory units, databases, and/or programs or software applications, all of which are considered within the scope of the present disclosure. For example, the computerized device 12 may have a computerized program installed within a memory device therein. The computerized program may be any application software, which may be referred to in the industry as an application, or simply an “app.” Current examples of these apps are commonly referred to by the entity that creates, markets or sells the app, such as Apps for iPhone® sold at an app store, or Google® apps. The app may include software code for performing a single action or multiple, related actions or tasks. The app may be compatible with, or used in conjunction with any other type of system software, middle ware or program.

One of the features of the application used by the system 10 is to identify the wireless tag device 11 to the user. Typically each wireless tag device 11 has a unique identification (ID) code. This ID code can be associated with a unique name for the user. To simplify the process of associating an ID code to a name, the wireless tag device 11 has to send out a identify status in the signal beacon. The process of enabling the ID status may be accomplished by activating the activation device 50, which may include doubletapping the package, using a magnetic sensor, or engaging a pushbutton. The application display may be showing many wireless tag devices 11, but the one wireless tag device 11 that is sending the ID status will have a different indication such as a different highlighting color. The user can then enter a name for this particular wireless tag device 11. This application data may be sent to a server database which stores the sensor status of all wireless tag devices 11 and users. When another tablet or phone running the application scans the wireless tag devices 11, the name associated with each wireless tag device 11 may be received from the server.

The system 10 may be enabled with conventional hardware components and software programs as well as specific apps installed within the computerized device 12 to receive the signal 32 transmitted from the wireless tag device 11. For example, the signal 32 may be received on a wireless receiver within the computerized device 12, such as a Bluetooth® receiver, capable of receiving short-wavelength UHF radio waves in an ISM band of between 2.4 GHz and 2.485 GHz. The functioning of the various components of the system 10 and the computerized device 12 may utilize a combination of existing software within the computerized device 12 for transmitting and receiving the wireless signals 32. For example, conventional software may include software associated with the functioning of Bluetooth® communication within the computerized device 12.

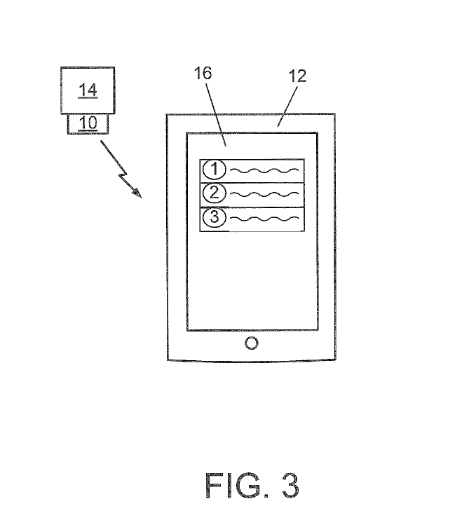

FIG. 3 is a schematic of the computerized device 12 used with the system for wireless moisture sensing 10 of FIGS. 1-2, in accordance with the first exemplary embodiment of the present disclosure. Relative to FIGS. 2-3, the computerized device 12, through the software operating thereon, may provide a graphical user interface (GUI) 16 or display that is capable of displaying information about the wireless tag devices 11. The GUI 16 of the computerized device 12 may include a listing or indexing of wireless tag devices 11 that have been detected. Each of the wireless tag devices 11 may correspond to an item within the list displayed on the GUI 16, and each item displayed may have information indicative of the corresponding system 10. For example, each item displayed may have an identification number of the wireless tag device 11 and an indication of activation of the wireless tag device 11 among other information. The indication of activation of the wireless tag device 11 may be a color-coded system, whereby wireless tag devices 11 that are currently activated, i.e., wireless tag devices 11 that have activation devices 50 that are experiencing an activation, are identified in one color, whereas inactive wireless tag devices 11 are identified in a different color. Optionally, the GUI 16 may include a map (not shown) of the locations of the wireless tag devices 11 affixed to assets 14 with an identification of specific wireless tag devices 11 on the map. The GUI 16 may further include other information about the wireless tag devices 11, including a listing of the total number of wireless tag devices 11 detected.

FIG. 4 is a schematic of the system for wireless moisture sensing 110, in accordance with a second exemplary embodiment of the present disclosure. The system for wireless moisture sensing 110, which may be referred to simply as ‘system 110’ may include any of the aspects disclosed within any part of the entire disclosure. The system 110 includes a wireless module 111 having a housing 120. A short-wavelength UHF radio wave wireless transmitter 130 is located within the housing 120, wherein the wireless transmitter 130 transmits a plurality of signals in an ISM band of between 2.4 GHz to 2.485 GHz. A processor 140 is coupled to wireless transmitter 130. An activation device 150 is positioned within the housing 120, wherein the activation device 150 is in communication with the processor 140, wherein the activation device 150 uses less than 10 μAh of power. A battery 160 is positioned within the housing 120 and provides a quantity of power to the processor 140 and the activation device 150. The system 110 further includes at least one moisture sensor 190 having at least four conductors 192. The moisture sensor 190 is removably coupled to the wireless module 111, wherein at least a portion of the at least four conductors 192 are in removable communication with the processor 140. As is shown in FIG. 4, the moisture sensor 190 is in communication with the wireless module 111 through a connector 194, which interfaces between the wireless module 111 and the at least one moisture sensor 190.

The system 110 of FIG. 4 may be a more-specific example of the system 10 discussed relative to FIGS. 1-2 herein. As is shown in FIG. 4, the housing 120 of the system 110 may contain and house the wireless transmitter 130, the processor 140, the activation device 150, a battery 160, an indicator 170, a timer 180, and a sensor input for connection to the moisture sensor 190, among other components. Specifically, the wireless transmitter 130 may be a 2.4 Ghz Digital Radio transceiver in communication with a printed PCB antenna 134. The processor 140 may include a MCU with Bluetooth® protocol enabled, to which the moisture sensor 190 is connected. The activation device 150, in one example, may include a micro electro-mechanical systems (MEMS) accelerometer in two-way communication with the processor 140. The indicator 170 may be an LED indicator which is housed at least partially within the housing 120 but is visible from a position external of the housing 120. The timer 180 may be integrated within the processor 140.

This system 110 may monitor moisture levels where the wireless modules 111 are positioned, whether the wireless modules 111 are in an asset such as a diaper or connected to a structure for moisture monitoring. The system 110 may use the radio transceiver using Bluetooth®-Low Energy protocol. The system 110 can also be used as a sensor input for a number of applications, including to sense moisture, temperature, or other conditions. Using a Bluetooth® beacon payload to transmit the sensor data as well as the device ID, allows a computerized device that is Bluetooth® 4.0 capable to receive the data from the sensor devices and the system 110.

In accordance with the system 110 of FIG. 4, the MCU may execute the Bluetooth® protocol from stored program code. The MCU may have permanent storage for a quantity of computer programs, and can permanently store configuration and operating parameters of the Bluetooth® protocol. To save power the MCU is normally in sleep state where it is not running any code. The MCU is woken up to run code either from an interrupt from one of the devices on the board, or by an internal timer. The MEMS accelerometer is configured to detect various events: motion, double-tap or orientation change. The MEMS accelerometer may wake up the processor by means of an interrupt signal 132 and the MCU may send control parameters and read data from the accelerometer. Thus, upon detection of the event, the MEMS accelerometer generates an interrupt signal to the MCU which causes the MCU to wake up from a sleep state and process the event.

The MCU may also wake up based on an internal timer. An antenna may be included for the MCU to transmit and receive radio frequency (RF) energy. The MCU may utilize power management to go to a low-power sleep state. The system 110 may not perform a Bluetooth® connection protocol to transfer the sensor information, as it is normally transmitting only using the beacon format. Thus the client receiver does not have to be associated to the tag to receive the information.

The use of a single or double tap detected by the accelerometer may signal an initial device configuration, may associate the system 110 with an asset by sending special signal code for identification, and may allow a connection between Bluetooth® client and host. The orientation of the system 110 when it is tapped is used to either turn it on and a different orientation used to turn it off. When it is turned off, it is no longer transmitting RF packets. The turn-off function can be disabled when the device is configured. The configuration can optionally be locked and never changed. A secure key code can be permanently stored; only clients that have the keycode can connect and change the operating parameters. The Bluetooth® beacon repetition rate is changed to a higher rate upon a double tap for a period of time and a code is sent as part of the beacon to signal the double-tap. The double-tap connection to the client can be disabled with a configuration parameter. This prevents unauthorized changes to the device setup.

When the accelerometer generates a motion detection interrupt, motion detection can be enabled and disabled, motion sensitivity and axis of acceleration can be configured, and an indicator LED flashes to show the motion has been detected. The Bluetooth® beacon repetition rate is changed to a higher rate upon motion detection for a period of time and a code is sent as part of the beacon to signal the motion detection. The maximum amount of time in the motion detected state can be configured. This prevents the system 110 from using up the battery when it is in motion for a long period of time as in truck transport. Minimum motion off time may be provided before re-enabling motion detection. For example to prevent the motion state being entered every time a truck carrying the asset tag stops at a traffic light. When the accelerometer generates an interrupt due to a change in orientation, orientation changes can be configured and enabled and orientation can change time delay configuration. The system 110 may include a “panic” button input used to generate an interrupt to the MCU.

The rules and protocols that are used to operate the system 110 can be configured to control the beacon transmission rate. These rules are based on time and sensor inputs to provide an immediate alert status and then to reduce the beacon repetition rate to lower battery usage. When the system 110 is set to airplane mode of operation, it is not transmitting beacons in normal operation; it is waiting for a signal from another device to start transmitting. After the beacons are sent for a programmable period of time, the system 110 then goes back to a receive-only mode. The signal to wake-up the transmitter is received by a separate receiver not using the Bluetooth® protocol. The sole purpose of this receiver is to wake-up the Bluetooth® transmitter.

In use of the system 110, the moisture sensor 190 may be positioned in a place likely to receive moisture (or where moisture detection is of concern). The moisture sensor 190 may be removably coupled to the wireless module 111, such that when moisture is detected, the processor 140 of the wireless module 111 is activated. Upon activation, the short-wavelength UHF radio wave wireless transmitter 130 located within the housing 120 transmits at least one signal in an ISM band of between 2.4 GHz to 2.485 GHz external of the housing 120, such as to a computerized device 12 (FIGS. 2-3) to inform a user that moisture has been detected. In one of many alternatives, the system 110 may lie dormant until an activation device 150 is activated. Upon activation, whether through physical movement of the activation device 150 or through a wake-up signal from the processor 140, moisture within the moisture sensor 190 may be determined and reported, accordingly.

Depending on the battery selected, this system 110 may operate over 5 years. In order to save power, the MCU must be in a sleep mode most of the time. The MCU may wake up from one of several sources; internal timer, interrupt from another device in the system or from a sensor. The internal timer is used to periodically transmit a signal or to monitor sensors or voltages. One of the possible sources for the external interrupt wakeup is from a MEMs accelerometer. This accelerometer can be used to identify the moisture sensor to application to associate it with the object. The internal timer may be used for the MCU to wakeup periodically and monitor the moisture sensor 190 which is connected to an analog to digital converter input.

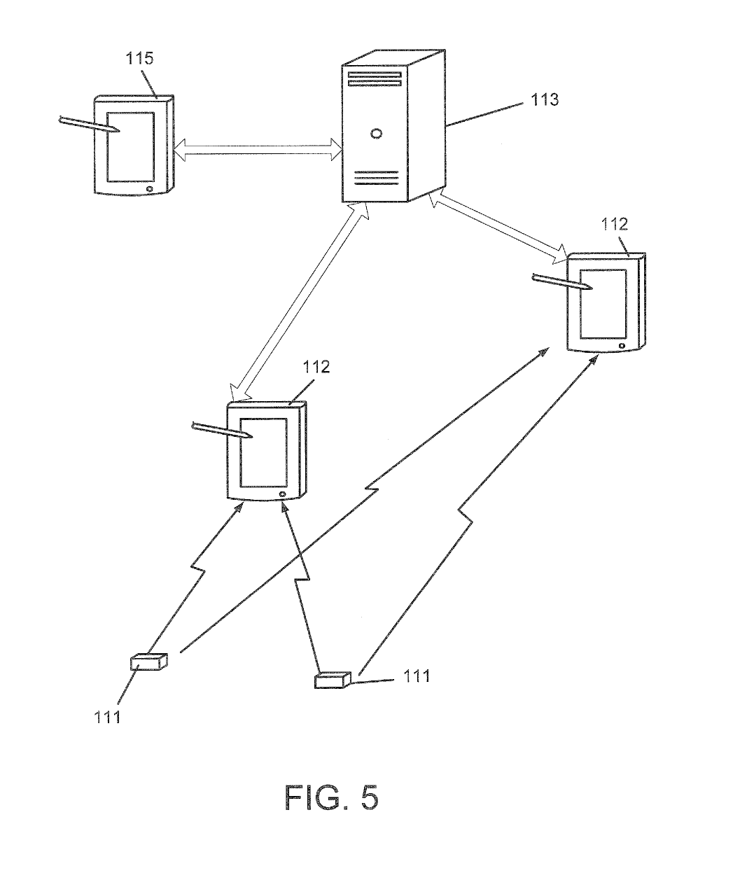

FIG. 5 is a schematic of the system for wireless moisture sensing 110, in accordance with the second exemplary embodiment of the present disclosure. The system 110 includes the wireless module 111 having an integral moisture sensor which is broadcasting a Bluetooth® beacon to at least one computerized device 112, such as a smartphone or tablet computer. Optionally, a fixed receiver to bridge the Bluetooth® data packets to the network can be used in place of the computerized device 112. Although not required, there are system configurations where multiple locations must be monitored on a server 113. In this case, the data is forwarded to the server 113 over standard network lines or wireless channels. The database in the server 113 may be viewable using a standard web interface from any computer network 115.

All of the wireless modules 111 may transmit a unique address as one of the data fields in the periodic transmission. It can be problematic to associate this unique sensor to a location or an asset to which it is attached, such that when the broadcast is received by the computerized device 112, it can be recognized by the unique sensor address. To overcome this problem, when the user attaches the wireless module 111, the user may double-tap the wireless module 111 which then allows the sensor to connect to a Bluetooth® client of the computerized device 112 for identification and configuration of the wireless module 111. This double-tap is detected when the wireless module 111 is tapped twice, it allows for the MCU to wake up, turn on a LED and transmit the address to a receiver which can transfer the device address to a server 113 database. This procedure allows for a simple and quick process to identify the wireless module 111. In addition, the double-tap interrupt can be used for a number of other purposes such as initial wireless module 111 deployment, turning the wireless module 111 on, package identification, and connecting to a Bluetooth® client to configure operating parameters. The indicator LED can be used for operator feedback that this state has been entered. The double-tap state can be terminated either by a time-out period or by receiving a data packet. In addition, the double-tap can be used to check the connection to the moisture sensor.

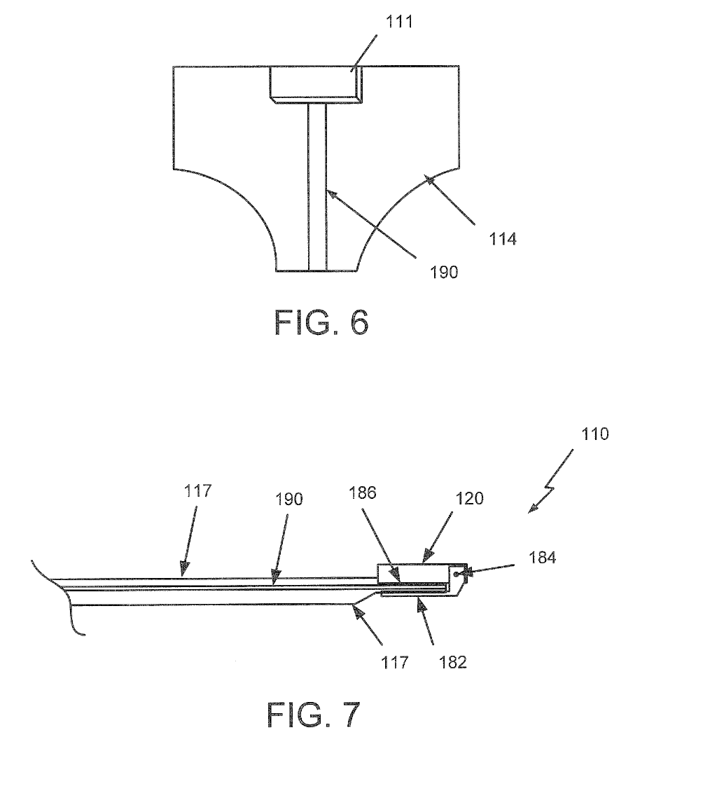

FIG. 6 is a front view diagram of the system for wireless moisture sensing 110 in use with an asset 114, in accordance with the second exemplary embodiment of the present disclosure. FIG. 7 is a cross-sectional side view diagram of the system for wireless moisture sensing 110 in use with an asset 114, in accordance with the second exemplary embodiment of the present disclosure. Specifically, FIGS. 6-7 illustrate the asset 114 as a disposable diaper with an embedded moisture strip 190. Relative to FIGS. 6-7 together, the asset 114 is shown as a diaper, but the asset 114 may include other personal sanitary products. The moisture sensor 190 may be a moisture-sensing strip which is embedded within the diaper, such as between two or more layers 117 of the diaper. The wireless module 111 may be removably affixed to at least one of the moisture sensor 190 and the asset 114, as is shown in FIG. 7.

The wireless module 111 may include a retaining clip 182 hingedly connected to the housing 120, wherein the retaining clip 182 is pivotal relative to the housing 120 using a pivot point or a spring-loaded hinged connection 184. An electrical contact 186 may be positioned between the housing 120 and the retaining clip 182. The moisture sensor 190 may include a moisture-sensing strip having at least one contact portion 187, wherein the at least one contact portion 187 is engagable between the retaining clip 182 and the housing 120. In this configuration, the contact portion 187 which is connected to the conductors of the moisture sensor 190, can be retained against the electrical contact 186 between the housing 120 and the retaining clip 182. Thus, the conductors of the moisture sensor 190 can be in communication with the processor (not shown). It is noted that the moisture strip can be printed with conductive ink onto a substrate formed from paper, plastic, or another material. When the wireless module 111 clips onto the edge of the diaper, a visual indication and optional audible indicator will let the user know that there is a good connection to the sensing strip on the diaper.

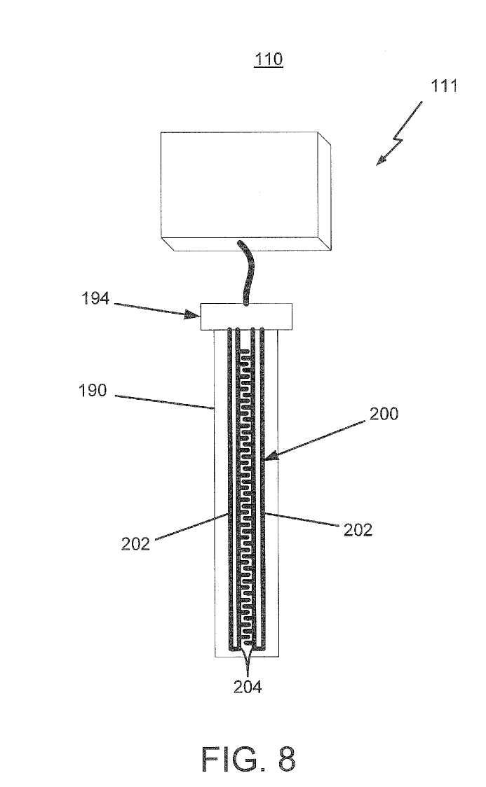

FIG. 8 is a schematic of the system for wireless moisture sensing 110, in accordance with the second exemplary embodiment of the present disclosure. Specifically, FIG. 8 illustrates the moisture sensor 190 as a moisture-sensing strip having four conductors 200. The four conductors 200 may include two outside conductors 202 and two center conductors 204. While conventional moisture sensors may include two conductors, the present disclosure includes four conductors 200 to prevent false detections of moisture when the sensor malfunctions. The problem with a moisture sensor with a 2 wire/conductor connection is that a broken connection cannot be differentiated from a dry condition. By using four conductors 200, the two outside conductors 202 can be used to drive a signal into the sensing conductors 204 in the center, thus validating the connection to the two sensing conductors 204 and verifying that there is no break in the length of the sensor strip 190.

For example, with reference to FIGS. 4 and 8, the processor 140 may determine a functionality of the moisture sensor 190 before the processor 140 determines the moisture condition with the moisture sensor 190. The functionality of the moisture sensor 190 may be determined by applying a voltage to each of the two outside conductors 202. If the corresponding voltage is received from each of the two outside conductors 202, it can be understood that the electrical circuit within the moisture sensor 190 is operational, in that it has no breaks within the circuitry. After determining that the moisture sensor 190 is operational, the processor 140 may then determine the moisture condition with the moisture sensor 190 by applying a voltage to one conductor of the moisture sensor 190, e.g., on one side of the moisture sensor 190, and sensing a corresponding voltage on a second conductor of the moisture sensor. This two-step process may prevent errors in no sensing moisture within the moisture sensor 190 due to malfunctions in the circuitry of the sensor itself. It is envisioned that the functionality check may be performed prior to each moisture detection operation, which may be done at predetermined intervals, such as every 5 seconds. The actual design of the sensing elements can be widely varied to provide the coverage area and sensitivity needed depending on the application.

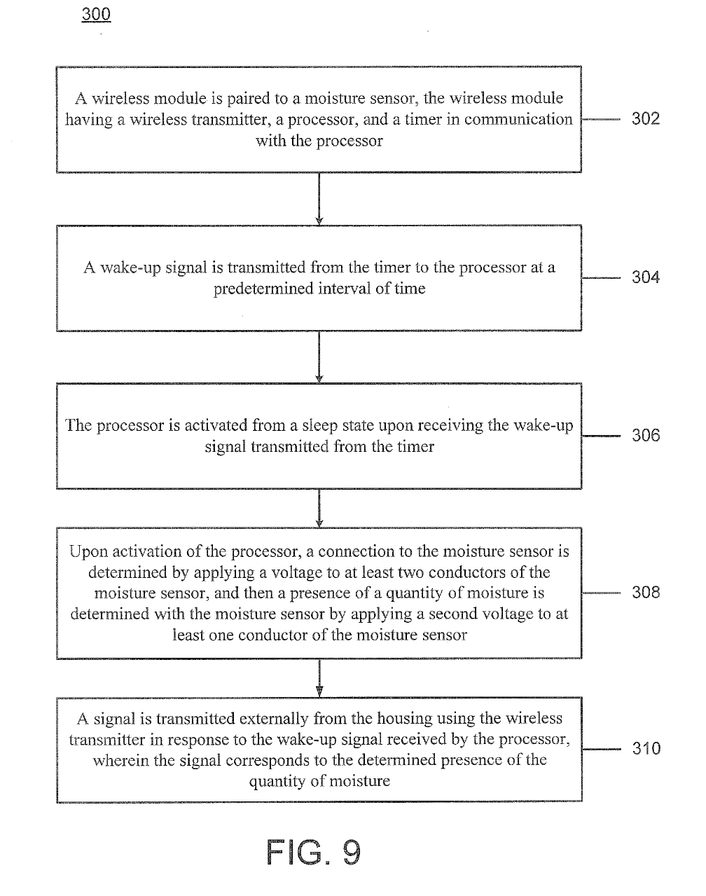

FIG. 9 is a flowchart 300 of a method for sensing moisture with a wireless tagging system, in accordance with the first exemplary embodiment of the present disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As is shown in FIG. 9, a wireless module is paired to a moisture sensor, the wireless module having a wireless transmitter, a processor, and a timer in communication with the processor (block 302). A wake-up signal is transmitted from the timer to the processor at a predetermined interval of time (block 304). The processor is activated from a sleep state upon receiving the wake-up signal transmitted from the timer (block 306). Upon activation of the processor, a connection to the moisture sensor is determined by applying a voltage to at least two conductors of the moisture sensor, and then a presence of a quantity of moisture is determined with the moisture sensor by applying a second voltage to at least one conductor of the moisture sensor (block 308). A signal is transmitted externally from the housing using the wireless transmitter in response to the wake-up signal received by the processor, wherein the signal corresponds to the determined presence of the quantity of moisture (block 310).

The method may include any number of additional steps, processes, or functions, including all disclosed within this disclosure. For example, the wireless module may be identified initially by activating an activation device within the wireless module, wherein activating the activation device further comprises at least one of: physically moving an accelerometer within the wireless module to activate the processor; magnetically influencing a magnet activation device in communication with the processor with a magnetic field to activate the processor; and physically contacting a push-activation device in communication with the processor to activate the processor.

Furthermore, the signal may be externally transmitted from the housing using the wireless transmitter transmitting the signal using short-wavelength UHF radio waves in an ISM band of between 2.4 GHz and 2.485 GHz. A second wake-up signal may be transmitted from a timer to the processor, wherein the timer is located within the housing, wherein the wireless transmitter transmits the signal externally from the housing in response to the second wake-up signal. Transmitting the signal from the wireless transmitter at a first predetermined repetition rate in response to the first wake-up signal may be done at a greater repetition rate than the repetition rate when transmitting the signal from the wireless transmitter at a second predetermined repetition rate in response to the second wake-up signal. A quantity of power may be provided to at least the processor and the accelerometer, wherein the accelerometer uses less than 10 μAh of the quantity of power.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A system for wireless moisture sensing, the system comprising:
a housing;
a wireless transmitter located within the housing;
a processor located within the housing, wherein the processor is in communication with the wireless transmitter;
a timer in communication with the processor, the timer communicating a wake-up signal to the processor at a predetermined interval of time;
an activation device in communication with the processor;
a battery located within the housing; and
at least one moisture sensor in communication with the processor.

2. The system for wireless moisture sensing of claim 1, wherein the activation device further comprises at least one of:
an accelerometer in communication with the processor, wherein physical movement of the accelerometer activates the processor;
a magnet activation device in communication with the processor, wherein the processor is activated by the magnetic activation device upon influence from a magnetic field; and
a push-activation device in communication with the processor, wherein the processor is activated by the push-activation device upon physical contact applied to the push-activation device.

3. The system for wireless moisture sensing of claim 1, wherein the wireless transmitter transmits a signal externally from the housing in response to the wake-up signal received by the processor, wherein the transmitted signal includes at least a device identification code and a moisture sensor status.

4. The system for wireless moisture sensing of claim 3, wherein the signal is transmitted periodically at a low rate, and upon a change of status of the at least one moisture sensor, the signal is transmitted at a high rate for a predetermined period of time.

5. The system for wireless moisture sensing of claim 1, wherein the processor is activated from a sleep state by receiving transmission of the wake-up signal, wherein upon receipt of the wake-up signal, the processor determines a moisture condition with the at least one moisture sensor.

6. The system for wireless moisture sensing of claim 5, wherein the processor determines the moisture condition with the at least one moisture sensor by applying a voltage to a first conductor of the at least one moisture sensor and sensing a corresponding voltage on a second conductor of the at least one moisture sensor.

7. The system for wireless moisture sensing of claim 6, wherein the at least one moisture sensor further comprises a moisture-sensing strip having four conductors, wherein the four conductors further comprise two outside conductors and two center conductors.

8. The system for wireless moisture sensing of claim 7, wherein the processor determines a functionality of the at least one moisture sensor before the processor determines the moisture condition with the at least one moisture sensor, wherein the functionality of the at least one moisture sensor is determined by applying a voltage to the two outside conductors.

9. The system for wireless moisture sensing of claim 7, wherein the four conductors of the moisture sensing strip further comprise a conductive ink printed onto at least one substrate, wherein the at least one substrate further comprises at least one of paper and plastic.

10. The system for wireless moisture sensing of claim 1, wherein the at least one moisture sensor is embedded within a personal sanitary product.

11. The system for wireless moisture sensing of claim 1, wherein the at least one moisture sensor is affixed to at least one of:
an article of bedding;
a habitable structure having at least one moisture barrier;
a quantity of soil; and
a mechanical device.

12. The system for wireless moisture sensing of claim 1, further comprising:
a computerized device receiving a signal from the wireless transmitter; and
an application executed on a processor of the computerized device, wherein the application provides a display with at least one tag identifier, wherein the signal received from the wireless transmitter corresponds to the at least one tag identifier.

13. The system for wireless moisture sensing of claim 12, wherein the wireless transmitter transmits the signal using short-wavelength UHF radio waves in an ISM band of between 2.4 GHz and 2.485 GHz.

14. A wireless moisture-sensing device comprising:
a wireless module comprising:
a housing;
a wireless transmitter located within the housing, the wireless transmitter transmitting signals in an ISM band of between 2.4 GHz to 2.485 GHz;
a processor located within the housing, wherein the processor is in communication with the wireless transmitter; and
a timer in communication with the processor, the timer communicating a wake-up signal to the processor at a predetermined interval of time;
an activation device in communication with the processor, the activation device comprising at least one of:
an accelerometer in communication with the processor, wherein physical movement of the accelerometer activates the processor;
a magnet activation device in communication with the processor, wherein the processor is activated by the magnetic activation device upon influence from a magnetic field; and
a push-activation device in communication with the processor, wherein the processor is activated by the push-activation device upon physical contact applied to the push-activation device;
a battery located within the housing; and
at least one moisture sensor having at least four conductors, wherein the at least one moisture sensor is removably coupled to the wireless module, wherein at least a portion of the at least four conductors are in removable communication with the processor.

15. The wireless moisture-sensing device of claim 14, further comprising a connector interfacing between the wireless module and the at least one moisture sensor.

16. The wireless moisture-sensing device of claim 14, wherein the wireless module further comprises a retaining clip hingedly connected to the housing, wherein the retaining clip is pivotal relative to the housing, wherein at least one electrical contact, in communication with the processor, is positioned between the housing and the retaining clip.

17. The wireless moisture-sensing device of claim 16, wherein the at least one moisture sensor further comprises a moisture-sensing strip having at least one contact portion, wherein the at least one contact portion is engagable between the retaining clip and the housing, wherein at least one conductor of the moisture-sensing strip is in electrical communication with the at least one electrical contact.

18. A method for sensing moisture with a wireless tagging system, the method comprising the steps of:
pairing a wireless module to a moisture sensor, the wireless module having a wireless transmitter, a processor, and a timer in communication with the processor;
transmitting a wake-up signal from the timer to the processor at a predetermined interval of time;
activating the processor from a sleep state upon receiving the wake-up signal transmitted from the timer;
upon activation of the processor, determining a connection to the moisture sensor by applying a voltage to at least two conductors of the moisture sensor, and then determining a presence of a quantity of moisture with the moisture sensor by applying a second voltage to at least one conductor of the moisture sensor; and
transmitting a signal externally from the housing using the wireless transmitter in response to the wake-up signal received by the processor, wherein the signal corresponds to the determined presence of the quantity of moisture.

19. The method of claim 17, wherein transmitting the signal externally from the housing using the wireless transmitter further comprises transmitting the signal using short-wavelength UHF radio waves in an ISM band of between 2.4 GHz and 2.485 GHz.

20. The method of claim 17, further comprising the step of identifying the wireless module by activating an activation device within the wireless module, wherein activating the activation device further comprises at least one of:
physically moving an accelerometer within the wireless module to activate the processor;
magnetically influencing a magnet activation device in communication with the processor with a magnetic field to activate the processor; and
physically contacting a push-activation device in communication with the processor to activate the processor.
